(19) United States
(12) Patent Application Publication
(10) Pub. No.: US 2006/0065028 A1
(43) Pub. Date: Mar. 30, 2006

(54) Ground rice hull composition and methods of use

(76) Inventor: Alan K. Nudelman, Westport, CT (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/231,663

(22) Filed: Sep. 21, 2005

Related U.S. Application Data
(60) Provisional application No. 60/611,902, filed on Sep. 21, 2004.

(51) Int. Cl. C05F 11/00

(52) U.S. Cl. 71/23

(57) ABSTRACT

Mixtures including soil and ground rice hulls are described herein. Also disclosed are methods for improving the growth of plant life, and a kit including soil and ground rice hulls

### CROSS-REFERENCE TO RELATED APPLICATIONS

The benefit under 35 U.S.C. §119(e) of U.S. provisional patent application Ser. No. 60/611,902 filed Sep. 21, 2004, the entire disclosure of which is incorporated herein by reference, is claimed.

### BACKGROUND

### Field of the Invention

The invention relates to compositions and methods to improve characteristics of soil. More particularly, the invention relates to ground rice hulls and their use as a soil amendment.

### BRIEF DESCRIPTION OF RELATED TECHNOLOGY

A grain of edible rice is the seed of a rice plant (semi-aquatic annual grass), and a grain of rice is harvested in its hull, a hard shell of the rice grain. The process of preparing edible rice includes a number of refinement steps, including the cleaning of the raw rice patty to remove foreign objects, hulling the cleaned rice patty to remove the hulls from the rice patty, and milling the rice to remove the bran layer. Different types of rice can be produced by variations in the refinement of raw rice. For example, brown rice is prepared by cleaning and then hulling the rice patty.

Parboiled rice is produced using a pressurized steam process prior to the milling stage of refinement. Rice is parboiled in the hull which softens the kernel, allowing the surface starch, bran, and other components to commingle. The water is then drained and the rice is carefully steam dried. The dried parboiled rice is sent through machines which separate the hull from the kernel. The rice hull is often discarded as a by-product of the refinement process.

The efficient growth of plant life in soil often requires the addition of a soil amendment. A soil amendment can be used to alter the texture of the soil, to provide aeration and water retention, among other aspects that are vital to plant growth. A common soil amendment is vermiculite, which is a naturally occurring mineral. Described herein are mixtures and methods that utilize rice hulls as a soil amendment.

### SUMMARY

One aspect of the mixtures and methods described herein is a mixture that includes soil and rice hulls.

Another aspect of the mixtures and methods described herein is a method for aerating soil by adding rice hulls to the soil.

Yet another aspect of the mixtures and methods described herein is a kit that includes soil and rice hulls.

Further aspects and advantages of the invention will be apparent to those skilled in the art from a review of the following detailed description, taken in conjunction with the appended claims. While the mixture, method of using the mixture, and the kit are susceptible of embodiments in various forms, the description hereinafter includes specific embodiments of the invention with the understanding that the disclosure is illustrative, and is not intended to limit the invention to the specific embodiments described herein.

### DETAILED DESCRIPTION OF THE PREFERRED EMBODIMENTS

Soil is made up of inorganic material, such as clay, sand, and rock particles, and organic matter, such as decaying animals and plants. When soil is used as a medium to grow plant life, the soil is often treated with a variety of materials to supplement the soil's ability to provide nutrients such as air, nitrogenous materials, and water. Described herein are soil mixtures that include ground rice hulls and methods of using ground rice hulls to improve the growth of plant life in soil.

A soil's texture can affect its capacity to support the growth of plant life. The texture of many common soils is determined by the amount of clay, silt and sand particles in the soil. A sandy soil has large particles and a high permeability to water, which negatively impacts the soil's ability retain water and store nutrients for use by the growing roots of a plant. A soil high in silt or clay has small particles with a low permeability to water, which allows such soils to retain water and nutrients for use by the plant roots. Table I lists various types of soil textures and the effect that the soil texture has on the soil's permeability and water retention:

TABLE I

| Soil Texture | Permeability | Water Retention |
|---|---|---|
| Sand | High | Low |
| Loam | Medium | Medium |
| Silt | Low | High |
| Clay | Low | High |

Soil amendments can be selected to effect a change in the texture of the soil and to improve a particular property that may be lacking from soil. For example, soils with a high clay content are able to retain water and nutrients, but a low permeability created by the high clay content makes it difficult for the growing roots to penetrate the soil. The plant roots can penetrate soil with a high sand content, but soil with a high sand content has poor nutrient and water retention properties. Preferably, a soil mixture has a balance between these competing considerations of permeability and water/nutrient retention.

Vermiculite is a mineral soil amendment that is made from particles of puffed mica. Vermiculite can be added to soil to alter the texture of soil with a high clay content to lighten up the soil to make it easier for the roots to penetrate the soil. Likewise, perlite is a volcanic rock based soil amendment that is preferably added to soil with a high clay content to loosen up the soil and increase the permeability of the soil. A list of common soil amendments and their effects on permeability and water/nutrient retention are listed below in Table II, wherein the effect on the soil is described ranging from a low to a high effect:

TABLE II

| Soil Amendment | Permeability | Water/Nutrient Retention |
|---|---|---|
| Sphagnum Peat Moss | low-medium | very high |
| Hardwood Bark | high | low-medium |
| Compost | low-medium | medium-high |
| Vermiculite | high | high |
| Perlite | high | low |
| Sand | high | low |
| Aged Manure | low-medium | medium |

The soil mixture described herein preferably includes one of more of the soil amendments listed in Table II to improve the permeability and/or water/nutrient retention of the soil. Thus, in addition to ground rice hulls, the soil mixture described herein preferably includes a soil amendment selected from the group consisting of peat moss, hardwood bark, compost, vermiculite, perlite, aged manure, and combinations thereof.

A raw rice patty includes a bran layer and a seed (also referred to as the kernel) that contains the majority of the nutritional value of the rice, and a rice hull, which is the outmost shell of the rice patty. The process of harvesting the edible rice kernel includes the separation of the rice hull from the kernel. One method for separating the rice kernel from the rice hull involves the boiling of the raw rice to improve separation of the rice hull from the kernel. This boiling process involves the use of a steam pressure process prior to the milling stage of refinement. After boiling effects a substantially complete separation of the hull from the kernel, the water is drained and the rice is dried by various methods, such as an open flame drier, and the dried boiled rice is sent through a machine (e.g., roller mills) which physically partitions the hull from the kernel. The rice hull is often discarded as a by-product of the refinement process. The separation of the hull from the kernel by boiling the raw rice is referred to herein as “parboiling,” and the rice hulls separated by parboiling are referred to herein as “parboiled” rice hulls.

The kernel or seed of the rice can be utilized as a food source and as a seed to grow rice plants. When used in a soil, the presence of a kernel or some portion thereof can, under the appropriate conditions, cause the unwanted growth of a rice plant in the soil. Thus, preferably the soil mixtures described herein include rice hulls that have been substantially sterilized to at least impede or prevent contaminant kernels from germinating a rice plant under the appropriate conditions. Parboiling of the rice substantially sterilizes the rice and substantially decreases the unwanted growth of rice plants in the soil. Thus, preferably a soil mixture described herein includes sterilized ground rice hulls, more preferably parboiled ground rice hull. Other methods of sterilization are contemplated, including steaming the rice to prevent the kernel from germinating a rice plant.

One variable aspect of soil that can be affected by a soil amendment is a soil's texture. Soil texture, or the way a soil feels, reflects the size of the soil particles. Sandy soils have large soil particles and feel gritty; clay soils have small soil particles and feel sticky. Soils that are either too sandy or too high in clay content are detrimental to the growth of plant life. When amending sandy soils, the goal is to increase the soil's ability to hold moisture and store nutrients. It has been found, quite surprisingly, that the addition of ground rice hulls to a sandy soil can increase the soil's ability to hold moisture and store nutrients. When amending clay soils, the goal is to improve soil aggregation, increase porosity and permeability, and improve aeration and drainage of the soil. It has been found, quite surprisingly, that the addition of ground rice hulls to a soil with a high clay content can improve one or more properties including soil aggregation, aeration, drainage, increase in porosity and increase in permeability.

Ground rice hulls can be mixed into wet or dry soil with a mechanical mixer. Ground rice hulls can be prepared by processing rice hulls through a mechanical grinder such as a Hammermill grinder available from Air Process Systems & Conveyors Co., Inc. (Westmont, Ill.). Preferably, ground rice hulls are used in the compositions and methods disclosed herein in a particular size or size distribution. Ground rice hulls of different sizes and/or size distributions can be prepared by passing the ground rice hulls through a screen wherein the screen contains holes of a fixed size. For example, screens for sieving ground rice hulls are commercially available according to a given mesh size, which is defined as the number of openings in one square inch of a screen. A list of commercially available screens is provided in Table III below:

TABLE III

| Mesh Size | Hole Size in Inches | Hole Size in Microns |
|---|---|---|
| 3 | 0.2650 | 6730 |
| 4 | 0.1870 | 4760 |
| 5 | 0.1570 | 4000 |
| 6 | 0.1320 | 3360 |
| 7 | 0.1110 | 2830 |
| 8 | 0.0937 | 2380 |
| 10 | 0.0787 | 2000 |
| 12 | 0.0661 | 1680 |
| 14 | 0.0555 | 1410 |
| 16 | 0.0469 | 1190 |
| 18 | 0.0394 | 1000 |
| 20 | 0.0331 | 841 |
| 25 | 0.0280 | 707 |
| 30 | 0.0232 | 595 |
| 35 | 0.0197 | 500 |
| 40 | 0.0165 | 400 |
| 45 | 0.0138 | 354 |
| 50 | 0.0117 | 297 |
| 60 | 0.0098 | 250 |
| 70 | 0.0083 | 210 |
| 80 | 0.0070 | 177 |
| 100 | 0.0059 | 149 |
| 120 | 0.0049 | 125 |
| 140 | 0.0041 | 105 |
| 170 | 0.0035 | 88 |
| 200 | 0.0029 | 74 |
| 230 | 0.0024 | 63 |
| 270 | 0.0021 | 53 |
| 325 | 0.0017 | 44 |
| 400 | 0.0015 | 37 |

It has been found that when ground rice hulls are used as a soil amendment the hulls can provide aeration and water permeability, alter the texture of the soil, and provide for improved water absorption. It has also been found, quite surprisingly, that when the rice hulls are ground to too small of a diameter (e.g., less than about 0.023 inches) that the hulls are too small to provide aeration and water permeability. It has also been found that when the ground hulls have too large of a diameter (e.g., more than about 0.23 inches) that the ground hulls separate out of the mixture when the hulls are mixed as a dry soil/hill mixture. Thus, the ground rice hulls preferably have a size in the range of about 30 mesh to about 6 mesh (e.g., a diameter in the range of about 0.023 inches and to about 0.135 inches), more preferably in the range of about 0.035 inches to about 0.130 inches. In another preferred embodiment, the ground rice hulls have a size between 20 mesh and 7 mesh (e.g., a diameter in the range of about 0.033 inches to about 0.111 inches).

The mixture described herein preferably includes water. It has been found that in a wet mixture substantially large sized rice hulls, including whole rice hulls, can be mixed into the wet soil to provide a substantially evenly mixed soil mixture to be used to provide aeration and water permeability to plant life. Thus, rice hulls present in a wet mixture (i.e., a mixture that includes water) preferably have a size of at least 30 mesh (e.g., a diameter of at least about 0.023 inches).

One aspect of the mixtures and methods described herein is a mixture, including soil and parboiled ground rice hulls, wherein the rice hulls have a size in the range of about 30 mesh to about 45 mesh (e.g., diameter in the range of about 0.023 inches to about 0.135 inches). Preferably, the parboiled rice hulls have a diameter in the range of about 20 mesh to about 45 mesh (e.g., a diameter in the range of about 0.035 inches to about 0.130 inches). In another preferred embodiment, the ground rice hulls have a size between 20 mesh and 7 mesh (e.g., diameter in the range of about 0.033 inches to about 0.111 inches).

The mixtures described herein can be used for a variety of applications. Nonlimiting examples of such applications include potting soil, nursery soil, top soil, seedling/propagating soil. The amount of rice hulls used in the soil depends upon the particular application for the soil (e.g., potting soil). For example, it may be advantageous to include a higher amount of rice hulls when the application requires a large amount of aeration and a soil structure that allows for rapid root growth. Thus, ground rice hulls are preferably present in the mixture in an amount in the range of about 5% to about 25% by weight based on the total weight of the mixture, more preferably in the range of about 10% to about 20%. Another aspect of the mixtures and methods described herein is a method of improving the growth of plant life, including the step of adding a mixture including soil, and parboiled ground rice hulls wherein the rice hulls have a size in the range of about 30 mesh to about 45 mesh (e.g., diameter in the range of about 0.023 inches to about 0.135 inches). In another preferred embodiment, the ground rice hulls have a size between 20 mesh and 7 mesh (e.g., diameter in the range of about 0.033 inches to about 0.111 inches).

Yet another aspect of the mixtures and methods described herein is a method of aerating soil, including the step of mixing parboiled ground rice hulls into the soil, wherein the rice hulls have a diameter in the range of at least about 30 mesh (e.g., 0.023 inches) into the soil. Preferably, the rice hulls have a size in the range of about 30 mesh to about 6 mesh (e.g., a diameter in the range of about 0.023 inches to about 0.135 inches), more preferably in the range of about 20 mesh to about 7 mesh (e.g., a diameter in the range of about 0.033 inches to about 0.111 inches).

Still another aspect of the mixtures and methods described herein is a soil kit, including soil and parboiled ground rice hulls with a size of about 20 mesh to about 6 mesh (e.g., a diameter in the range of about 0.035 inches to about 0.130 inches), and an additional soil amendment selected from the group consisting of peat moss, hardwood bark, compost, vermiculite, perlite, aged manure, and combinations thereof.

### EXAMPLE

The following example is provided to illustrate the invention but is not intended to limit the scope of the invention.

### EXAMPLE

A mixture of soil and ground parboiled rice hulls can be prepared by placing 10 pounds of garden soil (available from Scotts of Marysville, Ohio) and 2 pounds of parboiled ground rice hulls that are prepared by grinding whole parboiled rice hulls in a Hammermill grinder (available from Air Process Systems & Conveyors Co., Inc. of Westmont, Ill.) equipped with a screen with 10/64 of an inch holes (5 mesh screen). The ground rice hulls are then screened to eliminate most of the materials that are less than about 0.023 inches (30 mesh). The ground rice hulls that collect in the 30 mesh screen are between about 0.023 inches and about 0.111 inches in size. The soil and ground hulls are then mixed with a mechanical mixer until the ground hulls are evenly distributed throughout the soil.

The foregoing description is given for clearness of understanding only, and no unnecessary limitations should be understood therefrom, as modifications within the scope of the invention may be apparent to those having ordinary skill in the art. Throughout the specification, where compositions are described as including components or materials, it is contemplated that the compositions can also consist essentially of, or consist of, any combination of the recited components or materials, unless stated otherwise.

What is claimed is:

1. A mixture, comprising: soil and sterilized ground rice hulls, wherein said rice hulls have a diameter in the range of about 0.023 inches to about 0.135 inches.

2. This mixture of claim 1, wherein said sterilized ground rice hulls have a diameter in the range of about 0.035 inches to about 0.130 inches.

3. The mixture of claim 1, wherein said sterilized ground rice hulls have a diameter in the range of about 0.033 inches to about 0.111 inches.

4. This mixture of claim 1, further comprising an additional soil amendment selected from the group consisting of peat moss, hardwood bark, compost, vermiculite, perlite, aged manure, and combinations thereof.

5. The mixture of claim 1, wherein said sterilized, ground rice hulls are present in the mixture in an amount in the range of about 5% to about 25% by weight based on the total weight of the mixture.

6. The mixture of claim 5, wherein said sterilized, ground rice hulls are present in the mixture in an amount in the range of about 10% to about 20% by weight based on the total weight of the mixture.

7. The mixture of claim 1, wherein said sterilized ground rice hulls comprise parboiled rice hulls.

8. A method for growing plant life, comprising the step of adding the mixture of claim 1 to plant life.

9. A method of aerating soil, comprising the step of adding the mixture of claim 1 to soil.

10. A method of aerating soil, comprising the step of mixing parboiled, ground rice hulls into soil, wherein the rice hulls have a diameter in the range of about 0.023 inches to about 0.135 inches.

11. The method of claim 10, wherein said parboiled, ground rice hulls have a diameter in the range of about 0.035 inches to about 0.130 inches.

12. The method of claim 10, wherein said parboiled, ground rice hulls have a diameter in the range of about 0.033 inches to about 0.111 inches.

13. The method of claim 10, further comprising the step of mixing an additional soil amendment into the soil.

14. The method of claim 13, wherein said additional soil amendment is selected from the group consisting of peat moss, hardwood bark, compost, vermiculite, perlite, aged manure, and combinations thereof.

15. The method of claim 10, wherein said ground rice hulls are present in the mixture in an amount in the range of about 5% to about 25% by weight based on the total weight of the mixture.

16. The method of claim 15, wherein said ground rice hulls are present in the mixture in an amount in the range of about 10% to about 20% by weight based on the total weight of the mixture.

17. A mixture, comprising:
soil;
sterilized ground rice hulls;
and an additional soil amendment selected from the group consisting of peat moss, hardwood bark, compost, vermiculite, perlite, aged manure, and combinations thereof,
wherein said sterilized rice hulls are parboiled, have a diameter in the range of about 0.035 inches to about 0.130 inches, and comprise about 10% by weight to about 20% by weight of the mixture, based on the total weight of the mixture.
